(19) United States
(12) Patent Application Publication
(10) Pub. No.: US 2009/0308189 A1
(43) Pub. Date: Dec. 17, 2009

(54) STEERING DEVICE

(75) Inventors: Masaki Tomaru, Gunma (JP); Yuichi Tomaru, Gunma (JP); Kouhei Yonezawa, Chiba (JP); Takahiro Minamigata, Gunma (JP); Koji Nagai, Gunma (JP)

Correspondence Address: SIDLEY AUSTIN LLP, 717 NORTH HARWOOD, SUITE 3400, DALLAS, TX, 75201, US

(73) Assignee: NSK Ltd., Tokyo (JP)

(21) Appl. No.: 12/306,315

(22) PCT Filed: Jun. 25, 2007
(86) PCT No.: PCT/JP2007/062696

§ 371 Date: Feb. 10, 2009

(30) Foreign Application Priority Data
Jun. 29, 2006 (JP) 2006-179366

(51) Int. Cl. F16H 25/22; B62D 1/185

(52) U.S. Cl. 74/89.42; 74/493

(57) ABSTRACT

Provided are a steering device and a feed screw mechanism. The steering device is made so easy in the adjusting work of a backlash that it can eliminate the backlash reliably, even if the precision of the thread of a feed thread shaft or a feed nut is poor, thereby to improve the rigidity and to reduce the manufacturing cost of the feed screw mechanism. An upper-side end portion feed nut is urged upward of FIG. 8 by an upper-side disc spring so that an upper-side flank face of the thread ridge of the upper-side end portion fee nut is brought into close contact with the lower-side flank face of the thread ridge of a feed screw shaft. On the other hand, a lower-side end portion feed nut is urged downward of FIG. 8 by a lower-side disc spring so that a lower-side flank face of the thread ridge of the lower-side end portion fee nut is brought into close contact with the upper-side flank face of the thread ridge of the feed screw shaft. As a result, a feed nut and the feed screw shaft are cleared of the backlashes in the two upward and downward directions of FIG. 8.

### FIELD OF THE INVENTION

The present invention relates to a steering device and more particularly to a feed screw mechanism and a steering device enabling adjustment of a telescopic position and a tilt position of a steering wheel using the feed motion of the feed screw mechanism.

### BACKGROUND OF THE INVENTION

It is necessary to adjust a tilt position or a telescopic position of a steering wheel in response to the posture or build of a driver. A steering device is known which adjusts the tilt position or telescopic position using a feed screw mechanism using an electric motor to rotate a feed screw shaft which performs translatory motion with respect to a feed nut which is threadably engaged with the feed screw shaft.

As shown in Patent Literature 1, the conventional feed screw mechanism used in this type of steering device eliminates backlash between the feed screw shaft and the feed nut in order to produce a smooth feed motion.

FIG. 9 shows a feed screw mechanism according to Patent Literature 1. In other words, FIG. 9 shows the main elements of a feed screw mechanism according to Patent Literature 1 in which (1) is an enlarged front view, and (2) is a sectional view along the line C-C in (1). As shown in FIG. 9 (1), (2), the feed screw mechanism of Patent Literature 1 consists of a feed screw shaft 81 threadably engaged with a feed nut 82. A ball 83 having a spherical projection is integrally formed on the feed nut 82. The ball 83 is engaged with a sleeve on the moveable side of the steering device to form a spherical coupling. The translatory motion of the feed nut 82 adjusts the tilt position or telescopic position of a column (not shown).

A slit 84 is formed on feed nut 82 parallel to the shaft of the feed screw shaft 81 at a position which is shifted with a phase of 180 degrees from the ball 83. A bolt 85 for adjusting the interval with the slit 84 screws into the feed nut 82 from a direction which is orthogonal to the slit 84.

If the interval with the slit 84 is adjusted by screwing in the bolt 85, it is possible to adjust backlash between the feed nut 82 and the feed screw shaft 81. However the feed screw mechanism according to Patent Literature 1 requires skill to adjust the backlash between the feed nut 82 and the feed screw shaft 81 to a suitable value.

Furthermore a deviation in the pitch dimension of the thread of the feed screw shaft 81 and the feed nut 82 in an axial direction causes an indeterminate backlash between the feed screw shaft 81 and the feed nut 82. Therefore high-accuracy manufacture of the screw ridge of the feed screw shaft and the feed nut is required. Consequently the manufacturing costs of the feed screw mechanism cannot be reduced Furthermore if the screw ridge of the feed screw shaft and the feed nut becomes worn, backlash adjustment must be performed again.

Patent Literature 1: International Publication No. WO03/078234 Pamphlet

### DISCLOSURE OF THE INVENTION

### Problems to be Solved by the Invention

This invention has the object of providing a steering device and feed screw mechanism which uses a simple backlash adjustment operation to reduce manufacturing costs of a feed screw mechanism, improve rigidity and eliminate backlash to improve rigidity even when the precision of the screw ridge of the feed screw shaft and the feed nut is not high.

### Means for Solving the Problem

The above problem has been solved with the means described hereafter. In other words, according to a first invention, a feed screw mechanism performs feed motion using the relative motion of a feed screw shaft which is threadably engaged with a feed nut. The feed nut is formed from three feed nuts: a middle feed nut disposed in a middle position with respect to the axial direction of the feed screw shaft and end portion feed nuts respectively disposed on both axial end positions of the middle feed nut. A resilient member is interposed between the middle feed nut and the end portion feed nuts. The resilient member exerts an enlarging biasing force with respect to the axial interval between the middle feed nut and the end portion feed nuts in order to eliminate backlash with the feed nut.

A second invention includes the feed screw mechanism according to the first invention and is characterized in that the end portion feed nuts are supported to displace axially relative to and not to rotate relative to the middle feed nut.

A third invention includes the feed screw mechanism according to the second invention and is characterized in that, after adjusting the end portion feed nuts to a desired rotation position with respect to the middle feed nut, the end portion feed nuts can be fixed to prevent rotation relative to the middle feed nut.

A fourth invention provides a steering device including a steering shaft, a column, an electric actuator and a feed screw mechanism. The steering shaft mounts a steering wheel facing the vehicle rear. The column is mounted on the vehicle body via a body mounting bracket, axially supports the steering shaft to rotate freely and enables adjustment of a tilt position and telescopic position. The tilt position adjustment uses the tilt shaft as a support point and the telescopic adjustment is made along the shaft line of the steering shaft. The electric actuator is provided on the column or the vehicle body mounting bracket. The feed screw mechanism is driven by the electric actuator to perform tilt motion or telescopic motion of the column using the relative motion of a feed screw shaft threadably engaged with a feed nut. The feed nut is formed from three nuts: a middle feed nut disposed in a middle position with respect to the axial direction of the feed screw shaft and end portion feed nuts respectively disposed on both axial end positions of the middle feed nut. A resilient member is interposed between the middle feed nut and the end portion feed nuts. The resilient member exerts an enlarging biasing force with respect to the axial interval between the middle feed nut and the end portion feed nuts in order to eliminate backlash with the feed nut.

A fifth invention includes the steering device according the fourth invention and is characterized in that the end portion feed nuts are supported to displace axially relative to and not to rotate relative to the middle feed nut.

A sixth invention includes the steering device according to the fifth invention and is characterized in that after adjusting the end portion feed nuts to a desired rotation position with respect to the middle feed nut, the end portion feed nuts can be fixed to prevent rotation relative to the middle feed nut.

### EFFECT OF THE INVENTION

In the steering device and feed screw mechanism according to this invention, the feed nut is formed from three nuts: a middle feed nut disposed in a middle position with respect to the axial direction of the feed screw shaft and end portion feed nuts respectively disposed on both axial end positions of the middle feed nut. A resilient member is interposed between the middle feed nut and the end portion feed nuts. The resilient member exerts an enlarging biasing force with respect to the axial interval between the middle feed nut and the end portion feed nuts in order to eliminate backlash with the feed nut.

Thus manufacturing costs of a feed screw mechanism can be reduced and rigidity improved by using a simple backlash adjustment operation to ensure elimination of backlash even when the precision of the screw ridge of the feed screw shaft and the feed nut is not high.

Furthermore even if the screw ridge of the feed screw shaft and the feed nut becomes worn, since backlash can be eliminated by ongoing wear, the durability of the feed screw mechanism is improved

### BRIEF DESCRIPTION OF DRAWINGS

FIG. 1 is an overall perspective view showing an electric steering device according to this invention when mounted in a vehicle.

FIG. 2 is a schematic view of the main components including a partial sectional view showing an electric tilt steering device according to this invention.

FIG. 3 is a sectional view along the line A-A in FIG. 2.

FIG. 4 is a schematic view of the main components including a partial sectional view showing an electric telescopic steering device according to this invention.

FIG. 5 is a bottom view of FIG. 4.

FIG. 6 shows the main components of a feed screw mechanism of an example of the present invention wherein (1) is an enlarged front view and (2) is a fragmentary view of FIG. 1 taken in the direction of the arrow.

FIG. 7 is a sectional view along the line B-B in FIG. 6(2).

FIG. 8 is an enlarged sectional view of the main components showing the engaged section of the feed screw shaft and the feed nut.

FIG. 9 shows the main components of a conventional feed screw mechanism wherein (1) is an enlarged front view and (2) is a sectional view along the line C-C of (1).

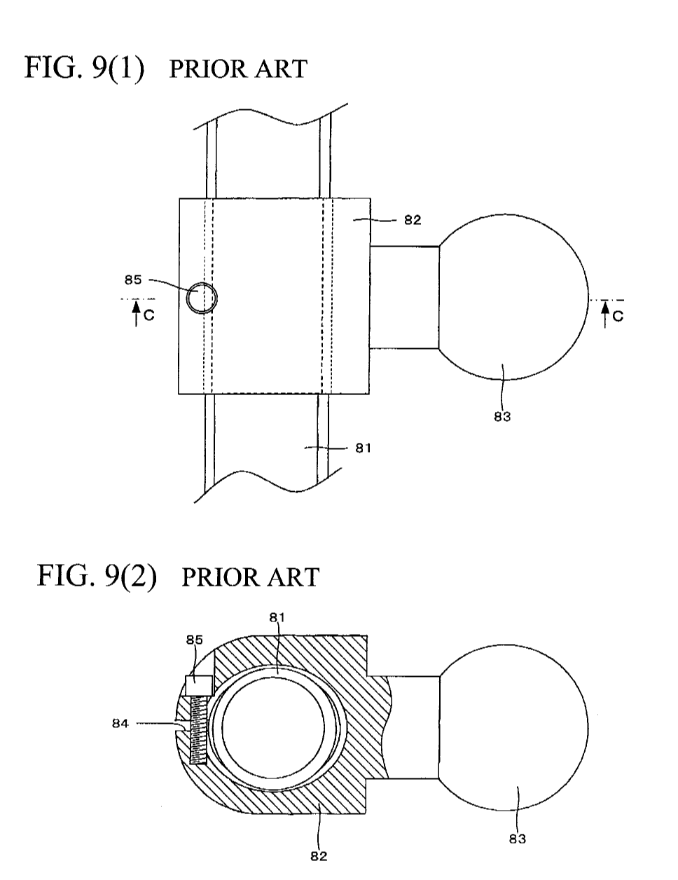

### EXPLANATION OF LETTERS OR NUMERALS

1 steering device
101 universal joint
102 middle shaft
103 universal joint
104 steering gear
105 tie rod
2 steering shaft
3 steering wheel
4 column
41 bracket
41A upper shaft support section
41B lower shaft support section
42 outer column
43 inner column
44A front shaft support section
44B rear shaft support section
45 aperture
45A front end
45B rear end
46 left side face
47 right side face
51 lower body mounting bracket
511 mounting section
512 pivoting section
513 pivot pin
52 upper body mounting bracket
521 mounting section
522, 523 side plate
522A, 523A inner side face
523B outer face
524 front plate
525 lower end
53 vehicle body
54 spacer
55 adjustment screw
56 lock nut
61 electric motor
611 output shaft
62 worm gear
71 feed screw shaft
71A upper flank
71B lower flank
72 worm wheel
73 feed nut
731 middle feed nut
731A end face
731B ring shaped indentation
731C upper flank
731D lower flank
732 end feed nut
732A male serration
732B upper flank
732C lower flank
74 ball
75 sleeve
75A inner periphery
76 fixed ring
761 female serration
762 long hole
763 bolt
77 coned disc spring
771 angular section
81 feed screw shaft
82 feed nut
83 ball
84 slit
85 bolt

### BEST MODE FOR CARRYING OUT THE INVENTION

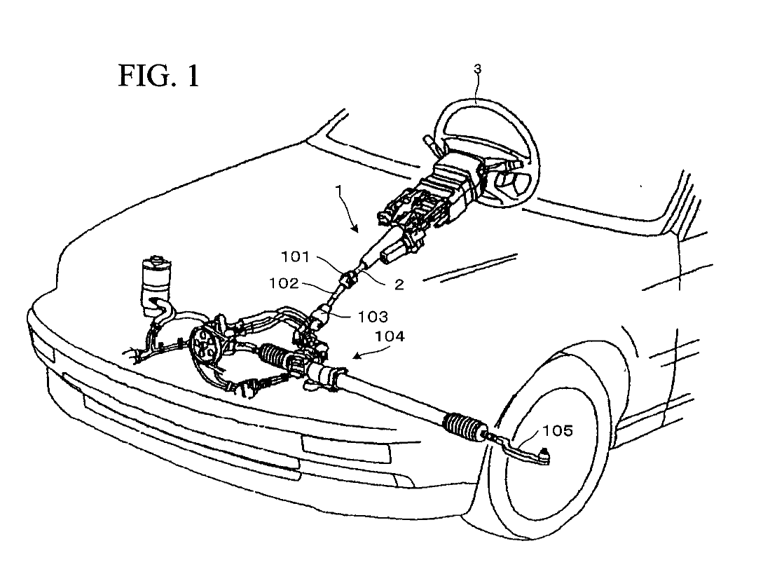

FIG. 1 an overall perspective view of a steering device 1 according to this invention mounted in a vehicle. As shown in FIG. 1, the steering device 1 is pivoted to rotate freely on a steering shaft 2. A steering wheel 3 is attached to the right end (towards vehicle rear) of the steering shaft 2. A middle shaft 102 is connected via a universal joint 101 to the left end (towards vehicle front) of the steering shaft 2.

A universal joint 103 is connected to the left end of the middle shaft 102. A steering gear 104 composed of a rack and pinion mechanism for example is connected to the universal joint 103.

When a driver rotates the steering wheel 3, torque is transmitted to the steering gear 104 via the steering shaft 2, the universal joint 101, the middle shaft 102, and the universal joint 103. The rack and pinion mechanism displaces a tie rod 105 and it is possible to vary the steering angle of the vehicle wheels.

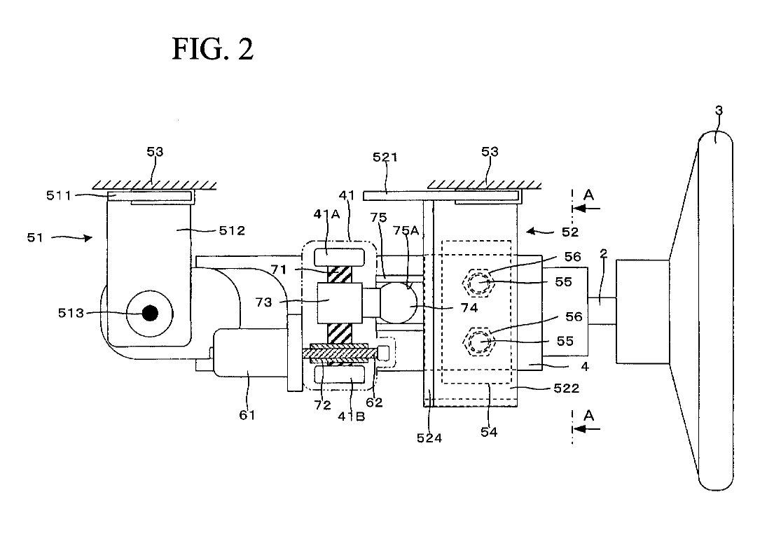

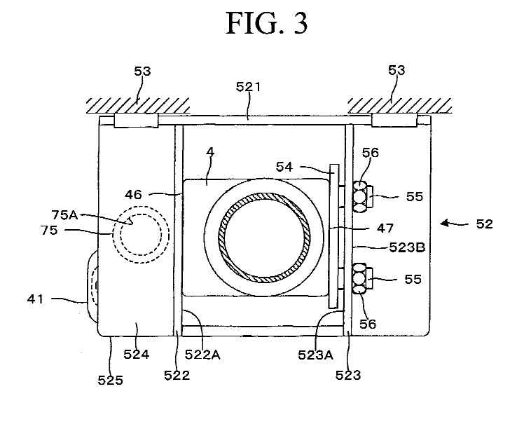

FIG. 2 is a schematic view of the main components including a partial sectional view showing an electric tilt steering device according to this invention. FIG. 3 is a sectional view along the line A-A in FIG. 2.

On the left of FIG. 2 (towards the vehicle front) a mounting section 511 formed on the top of a lower body mounting bracket 51 is fixed to the vehicle body 53. A pivoting section 512 extends downwardly from the mounting section 511. The left end of the column 4 is supported to reciprocate on the lower body mounting bracket 51 and uses a pivot pin 513 axially supported on the pivoting section 512 as a support point.

On the right of FIG. 2 (towards the vehicle rear) amounting section 521 formed on the top of an upper body mounting bracket 52 is fixed to the vehicle body 53. Side plates 522, 523 are formed downwardly from the mounting section 521. The left side face 46 and right side face 47 of the column 4 are sandwiched to slide and tilt by the inner side faces 522A, 523A of the side plates 522, 523. The steering shaft 2 is supported to rotate freely on the column 4 and a steering wheel 3 is mounted on the right end (towards vehicle rear) of the steering shaft 2.

An electric motor 61 which acts as an electric actuator is fixed to a bracket 41 which is integrated with the left side face 46 of the column 4. Both top and bottom ends of the feed screw shaft 71 are supported via a ball and roller bearing (not shown) on an upper shaft support section 41A and a lower shaft support section 41B. In the examples of this invention, a rotating electric motor 61 is used as the electric actuator. However it is possible to use a directional actuator such as a solenoid.

A worm gear 62 is integrally formed with the output shaft of the electric motor 61 and a worm wheel 72 fixed to the feed screw shaft 71 is threadably engaged with the worm gear 62. A speed reduction mechanism is formed by the worm wheel 72 and the worm gear 62 and the rotations of the electric motor 61 are transmitted to decelerate the feed screw shaft 71.

A feed nut 73 converting the rotations of the feed screw shaft 71 into linear motion is threadably engaged with the feed screw shaft 71. The feed nut 73 can move in a vertical direction in FIG. 2 along the feed screw shaft 71 near to the central shaft of the column 4. The feed mechanism formed by the feed screw shaft 71 and the feed nut 73 is a feed screw mechanism which converts the rotation of the feed screw shaft 71 into linear motion of the feed nut 73.

On the right side of FIG. 2, a ball 74 comprising a spherical projection is integrally formed with the feed nut 73. A spherical coupling is formed by integrally forming a cylindrical sleeve 75 on the front plate 524 (seen from FIG. 2) of the upper vehicle body mounting bracket 52 and inserting the outer periphery of the ball 74 to slide on the inner periphery 75A of the sleeve 75.

As shown in FIG. 3, in the space between the right face 47 of the column 4 and the inner face 523A of the side plate 523 on the right side of the upper vehicle body mounting bracket 52, a rectangular flat spacer 54 is interposed which is thinner than the dimensions of the space.

Two adjustment screws 55, 55 are screwed from the outer face 523B into the side plate 523 on the right side of the upper vehicle body mounting bracket 52. The screws 55, 55 are spaced with respect to the vertical direction (tilt adjustment direction) shown in FIG. 2 and FIG. 3.

When the adjustment screws 55, 55 are screwed in, the spacer 54 can be pressed towards the column 4 (the left direction of FIG. 3). Even if the space between the right face 47 of the column 4 and the inner face 523A of the side plate 523 is inclined as a result of manufacturing errors, the spacer 54 can be placed in uniform abutment with the right face 47 of the column 4 by suitably adjusting the amount of screwing of the adjustment screws 55, 55. Thus the tilt sliding resistance between the column 4 and the side plates 522, 523 can be set to a desired sliding resistance. Furthermore the tilting sliding resistance during tilting operation can be maintained to a fixed level irrespective of the tilt angle.

When the adjustment of the adjustment screws 55, 55 is completed, a lock nut 56, 56 is screwed on the adjustment screws 55, 55 and the lock nuts 56, 56 are fixed onto the outer face 523B of the side plate 523 in order to prevent loosening of the adjustment screws 55, 55.

When it becomes necessary to adjust the tilt position of the steering wheel 3, a switch (not shown) is operated in order to drive the electric motor 61 in either the forward or reverse direction. Thus the rotations of the electric motor 61 are transmitted to decelerate the worm gear 62 and then the worm wheel 72. Therefore the feed nut 73 for example descends in an axial direction along the feed screw shaft 71 as a result of the feed screw shaft 71 rotating together with the worm wheel 72.

Thus the ball 74 integrated with the feed nut 73 is also lowered relative to the column 4 and since the ball 74 is engaged with the sleeve 75, the column 4 tilts upwardly. When the ball 74 rises, the column 4 tilts downwardly. When the column 4 tilts, the ball 74 slides and rotates freely in the inner periphery 75A of the sleeve 75. Therefore the tilting motion of the column 4 is not impeded and unnecessary friction or stress is not produced between the ball 74 and the sleeve 75.

As shown in FIG. 2 and FIG. 3, in the examples of the present invention, the bracket 41 fixing the electric motor 61 and the sleeve 75 on the moving side to which the ball 74 is engaged are mounted near to the left side face 46 of the column 4 on the outer side of the tilt sliding face between the column 4 and the upper vehicle body mounting bracket 52. The bracket 41 and the sleeve 75 are mounted above the lower end 525 of the upper vehicle body mounting bracket 52. Thus since the drive system such as a feed screw mechanism is not disposed on the lower side of the column 4, the space between the driver's knees and the steering device can be maintained and thus the knees are prevented from making contact during a collision.

In the electric tilt steering device as described above, an electric motor 61 is fixed to the column 4. However the electric motor 61, the feed screw shaft 71 and the feed nut 73 may be mounted near the upper vehicle body mounting bracket 52 and the cylindrical sleeve 75 may be mounted near to the column 4.

Although the rotation of the feed screw shaft 71 is converted into the linear motion of the feed nut 73 in the electric tilt steering device described above, a female screw formed on the inner periphery of the worm wheel 72 can be threadably engaged with the feed screw shaft 71, the feed nut 73 can be fixed to the feed screw shaft 71 and the feed screw shaft 71 can be moved linearly by the rotations of the worm wheel 72. As a result the ball 74 can be moved upwardly or downwardly with respect to the column 4 in order to adjust the tilt position of the steering wheel 3.

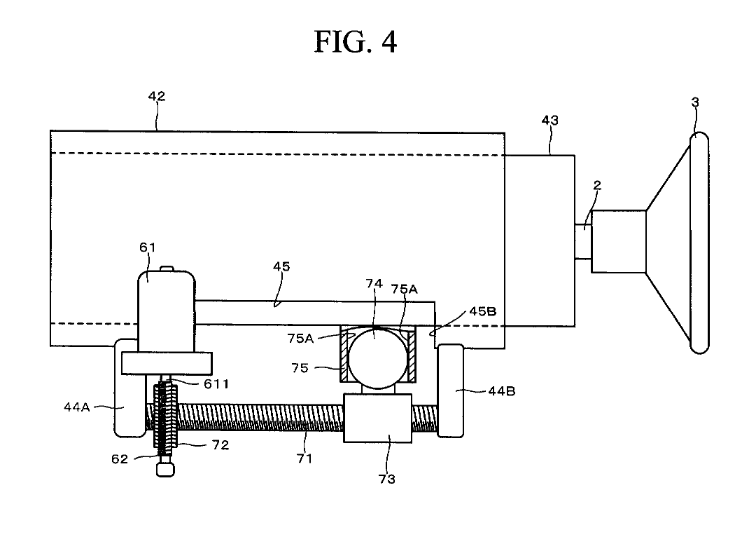

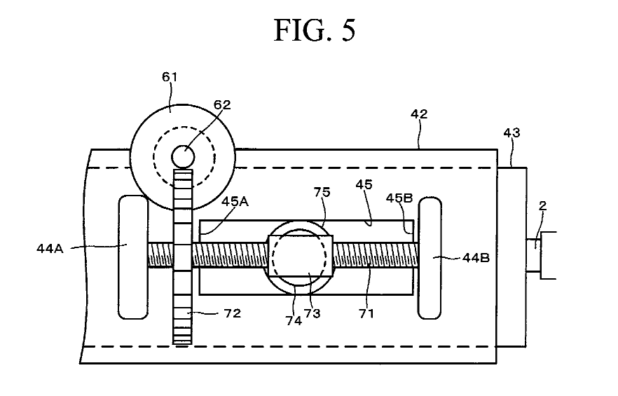

FIG. 4 is a schematic view of the main components including a partial sectional view showing an electric telescopic steering device in which a telescopic position of the steering wheel 3 is adjusted using an electric actuator. FIG. 5 is a bottom view of FIG. 4.

An inner column 43 is engaged with the hollow cylindrical outer column 42 to slide telescopically in an axial direction (left-right direction in FIG. 4). A rectangular aperture 45 is formed on the lower section of the outer column 42. The sleeve 75 fixed to the inner column 43 projects downwardly from the aperture 45. The outer periphery of the sleeve 75 abuts with the front end 45A and the rear end 45B of the aperture 45 when the telescopic position is adjusted. Thus the aperture 45 functions as a stopper to prevent rotation with respect to the rotating direction of the inner column 43.

A steering shaft 2 is supported to freely rotate on the inner column 43. A steering wheel 3 is mounted on the right end (towards vehicle rear) of the steering shaft 2. A front shaft support section 44A and a rear shaft support section 44B are integrated with and project downwardly from the lower face of the outer column 42 sandwiching the aperture 45. The front and rear ends of the feed screw shaft 71 are respectively supported by a ball and roller bearing (not shown). An electric motor 61 is fixed to the side face of the outer column 42.

A worm gear 62 is integrally formed with the output shaft 611 of the electric motor 61 and a worm wheel 72 fixed to the feed screw shaft 71 is threadably engaged with the worm gear 62. A speed reduction mechanism is formed by the worm wheel 72 and the worm gear 62 and the rotations of the electric motor 61 are transmitted to decelerate the feed screw shaft 71.

A feed nut 73 converting the rotations of the feed screw shaft 71 into linear motion is threadably engaged with the feed screw shaft 71. A ball 74 comprising an upward spherical projection is integrally formed with the feed nut 73. A spherical coupling is formed by engaging the outer periphery of the ball 74 to slide on the inner periphery 75A of the sleeve 75.

When it becomes necessary to adjust the telescopic position of the steering wheel 3, a switch (not shown) is operated in order to drive the electric motor 61 in either the forward or reverse direction. Thus the rotations of the electric motor 61 are transmitted to decelerate the worm gear 62 and then the worm wheel 72. Therefore the feed nut 73 for example is displaced to the left (towards vehicle front) along the feed screw shaft 71 as a result of the feed screw shaft 71 rotating together with the worm wheel 72.

Thus the ball 74 integrated with the feed nut 73 is also displaced in the left-right direction. Since the ball 74 is engaged with the sleeve 75, the inner column 43 is telescopically displaced in a left-right direction. When the ball 74 displaced in a left-right direction (towards vehicle rear), the inner column 43 is telescopically displaced in a left-right direction. When the inner column 43 is telescopically displaced in a left-right direction, the ball 74 slides and rotates freely in the inner periphery 75A of the sleeve 75. Therefore the telescopic motion of the inner column 43 is not impeded and unnecessary friction or stress is not produced between the ball 74 and the sleeve 75.

In the electric telescopic steering device described above, although the rotation of the feed screw 71 is converted into the linear motion of the nut 73, a female screw formed on the inner periphery of the worm wheel 72 can be threadably engaged with the feed screw 71, the nut 73 can be fixed to the feed screw 71 and the feed screw 71 can be moved linearly by the rotations of the worm wheel 72. As a result the ball 74 can be moved in a longitudinal direction with respect to the vehicle body in order to adjust the telescopic position of the steering wheel 3.

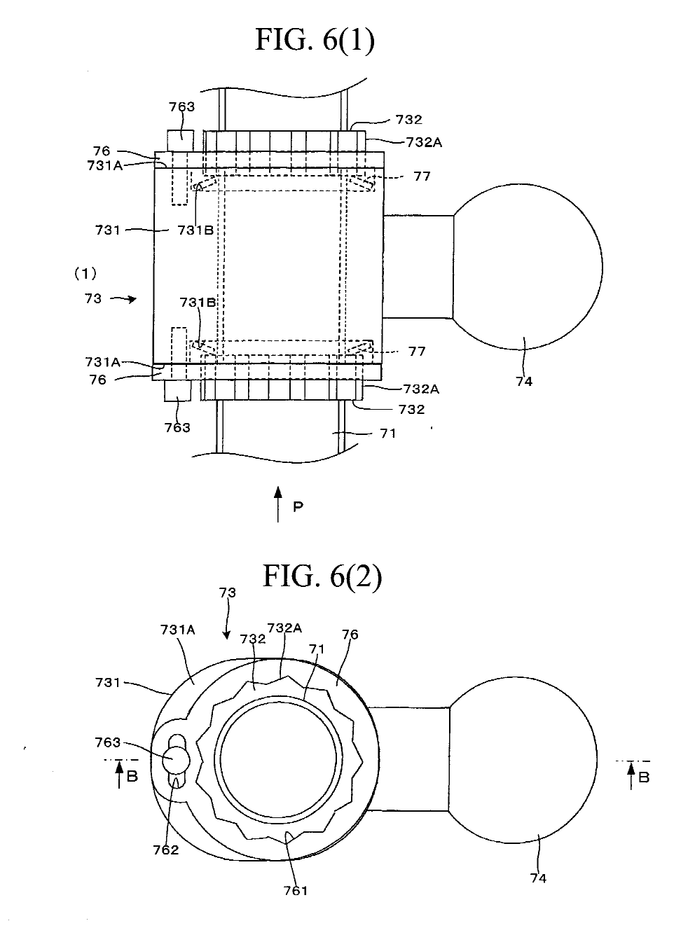

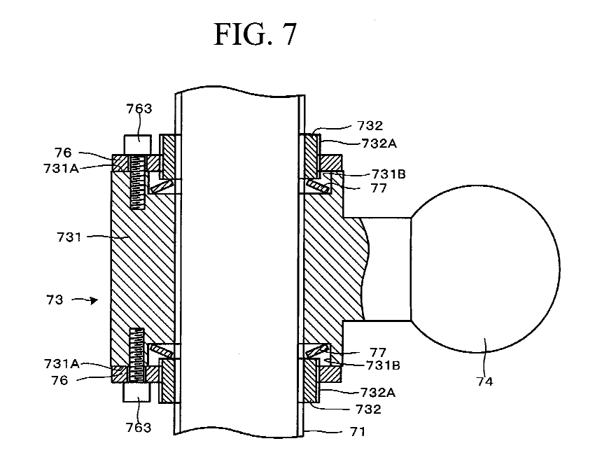

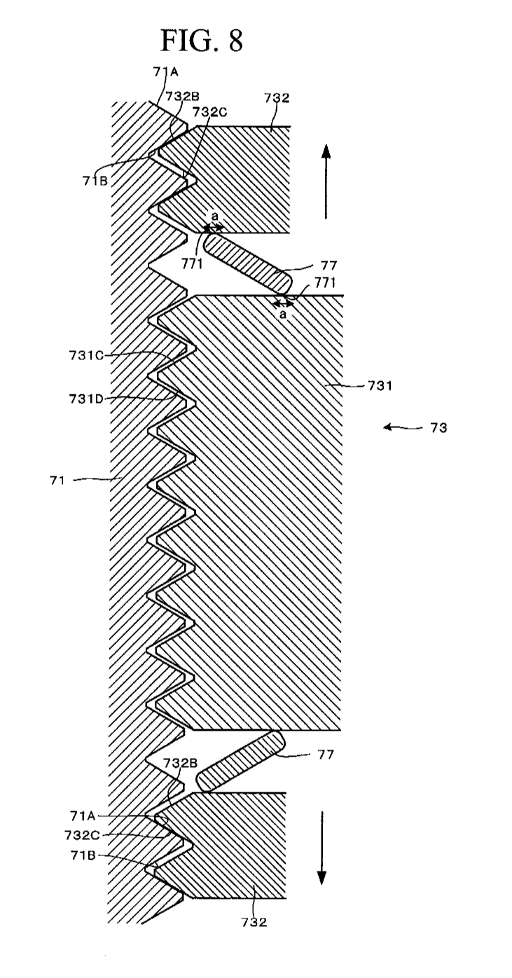

Next the feed screw mechanism comprising the feed screw shaft 71 and the feed nut 73 will be described in further detail. FIG. 6 shows the main components of a feed screw mechanism of an example of the present invention wherein (1) is an enlarged front view and (2) is a fragmentary view of FIG. 1 taken in the direction of the arrow P. FIG. 7 is a sectional view along the line B-B in FIG. 6(2). FIG. 8 is an enlarged sectional view of the main components showing the threaded section of the feed screw shaft 71 and the feed nut 73.

As shown in FIG. 6 and FIG. 7, the feed nut 73 is divided into three sections from the axial direction of the feed screw shaft 71 and comprises three feed nuts being the middle feed nut 731 and the end feed nuts 732, 732. The middle feed nut 731 is disposed in a middle position with respect to the axial direction of the feed screw shaft 71. The end feed nuts 732, 732 are respectively disposed on the end positions (the upper end and lower end in FIG. 6(1) and FIG. 7) in an axial direction of the middle feed nut 731.

A ball 74 having a spherical projection is integrally formed on the middle feed nut 731. Male serrations 732A, 732A formed as 13 equidistant triangular indentations are formed on the outer periphery of the end feed nuts 732, 732.

Disk-shaped fixed rings 76, 76 are respectively disposed on both axial ends of the middle feed nut 731. Female serrations 761, 761 formed as 13 equidistant triangular indentations are formed on the inner periphery of the fixed rings 76, 76. Male serrations 732A, 732A on the outer periphery of the end feed nuts 732, 732 are tightly engaged with the female serrations 761, 761.

A long hole 762 is formed on the fixed rings 76, 76. The fixed rings 76, 76 can be fixed to the end face 731A of the middle feed nut 731 by screwing bolts 763, 763 passing through the long hole 762 into a bolt hole formed in the middle feed nut 731.

Backlash is eliminated between the end feed nuts 732, 732 and the feed screw shaft 71 by loosening the bolt 763, respectively rotating the end feed nuts 732, 732 together with the fixed ring 76 in the range of the long hole 762 and then rotating in a direction enlarging the axial interval between the middle feed nut 731 and the end feed nut 732, 732. Then the bolt 763 is tightened. Thus the end feed nuts 732, 732 can displace only with respect to the fixed rings 76, 76 in an axial direction of the feed screw shaft 71 and cannot rotate relative to the feed screw shaft 71.

Ring shaped indentations 731B, 731B are formed on the end faces 731A, 731A of the middle feed nut 731. A coned disc spring 77, 77 is interposed as a resilient body in the ring shaped indentations 731B, 731B. The coned disc spring 77 preferably produces a large biasing force and requires only a small space. The biasing force of the coned disc spring 77 biases the end feed nut 732 in a direction in which the axial interval between the middle feed nuts 731 is enlarged and thus eliminates backlash between the feed nut 73 and the feed screw shaft 71.

In this example, a single coned disc spring 77 may be provided for each indentation 731B or a plurality may be provided. The orientation of the coned disc spring 77 may be inverted through 180 degrees. A resilient body such as a metal coil spring or a rubber or resinous non-metallic resilient body may be used.

FIG. 8 is an enlarged sectional view of the main components showing the engaged section of the feed screw shaft 71 and the feed nut 73. As shown in FIG. 8, the upper end feed nut 732 is biased upwardly in FIG. 8 by the upper coned disc spring 77. The upper flank 732B of the screw ridge of the upper end feed nut 732 is fitted tightly to the lower flank 71B of the screw ridge of the feed screw shaft 71.

The lower end feed nut 732 is biased downwardly in FIG. 8 by the lower coned disc spring 77. The lower flank 732C of the screw ridge of the lower end feed nut 732 is fitted tightly to the upper flank 71A of the screw ridge of the feed screw shaft 71.

Since the middle feed nut 731 is biased by the upper and lower coned disc springs 77, 77 and is held in a middle position in FIG. 8, the upper flank 731C and the lower flank 731D of the screw ridge of the middle feed nut 731 allow for a space between the upper flank 71A and the lower flank 71B of the screw ridge of the feed screw shaft 71. FIG. 8 shows an example of a triangular screw being the screw ridge of the feed screw shaft 71. However various screw ridge shapes such as trapezoid or buttress thread screws may be employed in the feed screw mechanism.

When the feed screw shaft 71 is rotated by the electric motor 61, a load to move the outer column or the like is applied to the middle feed nut 731 which is held in a middle position as described above. Thus either the upper or the lower coned disc spring 77, 77 is compressed. The outer column 42 or the like is normally displaced by that compressive force. Since the outer column 42 is displaced via a spring, smooth motion without shocks is enabled.

When a larger load than expected is applied, the compression displacement of the coned disc springs 77, 77 increases and the flank 731C or 731D of the middle feed nut 731 contacts the flank 71A or 71B of the feed screw shaft 71. Therefore since force is transmitted via the contacting faces, the operation of the screw feed is not impeded.

When the plate screw 77 expands or contracts, the angular section 771 of the coned disc spring 77 displaces slightly as shown by the arrow a in FIG. 8 on the end face of the middle feed nut 731 and the end feed nut 732. When an irregular force interferes with this relative motion, the compression (or expansion) of the coned disc spring 77 will fluctuate irregularly This effect results in malfunctions such as preventing smooth screw feed, noise produced by screws under going contra-rotation or an unstable load on the electric motor 61.

In order to prevent these types of malfunctions, the angular section 771 should be processed in order to slide smoothly on the end face described above. This type of processing may include for example providing an are on the angular section 771 as shown in FIG. 8, coating or painting a low friction material on the end face or adhering a low friction sheet.

As a result, backlash is eliminated in the feed nut 73 and the feed screw shaft 71 with respect to both the upward and downward direction in FIG. 8. Thus adjustment of the tilt position and the telescopic position of the steering wheel 3 can be performed smoothly and the rigidity of the steering wheel 3 after the position adjustment can be improved.

Since backlash can be eliminated using a simple backlash adjustment operation even when the accuracy of the feed screw shaft 71, the middle feed nut 731 and the end feed nuts 732 is poor, it is possible to reduce manufacturing costs for the feed screw mechanism. Furthermore even when the end feed nut 732, the middle feed nut 731 and the feed screw shaft 71 become worn, the durability of the feed screw mechanism is improved since it is possible to eliminate backlash with respect to the additional wear.

In the examples above, the examples are applied to a steering device which performs only one of a telescopic position adjustment or a tilt position adjustment. However this invention can be applied to a steering device which adjusts both a telescopic position and a tilt position.

### INDUSTRIAL APPLICABILITY

The feed screw mechanism of the present invention can be applied not only to a steering device as shown in the example but also to a feed screw mechanism in fields such as machine tools.

1. A feed screw mechanism performing feed motion using the relative motion of a feed screw shaft threadably engaged with a feed nut,
wherein the feed nut is formed from three feed nuts comprising a middle feed nut disposed in a middle position with respect to the axial direction of the feed screw shaft, and end portion feed nuts respectively disposed on both axial end positions of the middle feed nut; and
a resilient member is interposed between the middle feed nut and the end portion feed nuts, the resilient member exerting an enlarging biasing force with respect to the axial interval between the middle feed nut and the end portion feed nuts in order to eliminate backlash with the feed nut.

2. A feed screw mechanism according to claim 1, wherein the end portion feed nuts are supported to displace axially relative to and not to rotate relative to the middle feed nut.

3. A feed screw mechanism according to claim 2, wherein, after adjusting the end portion feed nuts to a desired rotation position with respect to the middle feed nut, the end portion feed nuts can be fixed to prevent rotation relative to the middle feed nut.

4. A steering device comprising a steering shaft, a column, an electric actuator and a feed screw mechanism, wherein
the steering shaft mounts a steering wheel facing the vehicle rear,
the column is mounted on the vehicle body via a body mounting bracket, axially supports the steering shaft to rotate freely and enables adjustment of a tilt position using the tilt shaft as a support point and a telescopic position along the shaft line of the steering shaft,
the electric actuator is provided on the column or the vehicle body mounting bracket,
the feed screw mechanism is driven by the electric actuator to perform tilt motion or telescopic motion of the column using the relative motion of a feed screw shaft threadably engaged with a feed nut,
the feed nut is formed from three feed nuts comprising a middle feed nut disposed in a middle position with respect to the axial direction of the feed screw shaft and end portion feed nuts respectively disposed on both axial end positions of the middle feed nut,
a resilient member is interposed between the middle feed nut and the end portion feed nuts, the resilient member exerting an enlarging biasing force with respect to the axial interval between the middle feed nut and the end portion feed nuts in order to eliminate backlash with the feed nut.

5. A steering device according claim 4, wherein the end portion feed nuts are supported to displace axially relative to and not to rotate relative to the middle feed nut.

6. A steering device according to claim 5, wherein after adjusting the end portion feed nuts to a desired rotation position with respect to the middle feed nut, the end portion feed nuts can be fixed to prevent rotation relative to the middle feed nut.
